(19) United States
(12) Patent Application Publication
(10) Pub. No.: US 2013/0341123 A1
(43) Pub. Date: Dec. 26, 2013

(54) EMERGENCY DEVICE WITH QUICK RELEASE HOOK

(71) Applicant: Vincent McMahon, New City, NY (US)

(72) Inventor: Vincent McMahon, New City, NY (US)

(21) Appl. No.: 13/528,869

(22) Filed: Jun. 21, 2012

(51) Int. Cl. A62B 35/00; B65D 33/14

(52) U.S. Cl. 182/6; 182/3; 206/388

(57) ABSTRACT

An escape system has a harness, pants, a hook, a rope, a slider, a carabiner and a bag. The bag is packed so that the rope is packed into the rope pocket of the bag and threaded through a channel of the slider, the slider and the carabiner attached thereto are packed in the bag on top of the rope, the hook is inside the bag and attached to a hook connector disposed on a flap of the bag, and the flap is connected to the front side of the bag. The carabiner is attached to a D-ring on the harness that is attached to pants worn by a human. In use, when the flap is pulled away from the front side, the hook is automatically pulled out of the bag, eliminating a step of groping for the hook during an emergency escape.

### BACKGROUND OF THE INVENTION

The present invention relates to an emergency survival device, and more particularly, is directed to device comprising a hook, slider, rope and bag for use in an emergency exit from a window of a building.

In 2005, two firefighters died when they jumped out of a burning building in Bronx, New York.

In response, the New York legislature passed New York State Assembly A07785, effective Sep. 30, 2007, amending section 27-a of the New York labor law requiring that firefighters be provided with safety systems (harnesses, belts, ascenders, carabiners etc.) that comply with the National Fire Protection Association (NFPA) 1983 Standard on Fire Service Life Safety Rope and System Components, and requiring that the equipment be maintained and that firefighters be trained in its use.

The current state of the art escape system used by the Fire Department of New York (FDNY) is shown in FIG. 1, and comprises hook 10, rope 20, slider 30 with carabiner 40, bag 50, bunker pants 60 and harness 70. FIG. 1 shows bag 50 on the right side of the firefighter, as is the FDNY practice; however, the bag could also be on the left side. According to procedure, an escape system is destroyed after it is used, that is, the escape systems are single-use devices. Of course, a firefighter may carry the escape system many times prior to actually using it.

The escape system of FIG. 1 has been used on at least five separate occasions, saving five different firefighters from death.

Harness 70 may be the Gemtor 541-NYC third generation Class II harness used by FDNY. Harness 70 includes belt 70W, left leg strap 70L, right leg strap 70R and D-ring 70D attached to belt 70W by a length of webbing.

Prior to responding to a fire emergency, a firefighter puts on his or her bunker pants 60 made of fire-resistant material and having connections for harness 70. The firefighter steps into the left leg loop formed by left leg strap 70L, then pulls right leg strap 70R around his or her right leg, and fastens belt 70W using a removable hook. The firefighter attaches the appropriate carriers on the outside of bunker pants 60 to leg straps 70L, 70R and belt 70W.

The firefighter packs rope 20 and hook 10 in bag 50; hook 10 is connected to rope 20 which is embraced by slider 30, having connected thereto carabiner 40. The length of rope 20 between hook 10 and slider 30 is preconfigured with the assumption that hook 10 will be attached to a window frame. If hook 10 is attached remotely from the window, the firefighter must manually extend the length of rope 20 that is between hook 10 and slider 30. The firefighter attaches packed bag 50 to belt 70W and leg strap 70R (see discussion of FIG. 4). Finally, the firefighter puts on his or her firefighting jacket. Now, bag 50 is conveniently accessible but is partially protected from the environment by the firefighting jacket.

During a fire emergency, if the firefighter decides it is necessary to exit from window 6 of a building, the firefighter reaches for bag 50, and rolls out window 6. When the firefighter is on the outside of the building, his or her bodyweight forms a load suspended from slider 30 via carabiner 40 attached to D-ring 70D, the length of the D-ring strap becomes taut. To descend, the firefighter uses the handle 30G (see FIG. 3) of slider 30 and lets rope 20 feed through slider 30 at a comfortable rate. Rope 20 feeds out of bag 50 and through slider 30. The firefighter then descends down outer wall 7 of the building suspended in harness 70, either to the ground, a nearby roof or a rescue ladder. If the firefighter wishes, he or she can walk their feet down against the outside of the building, to rappel down the outside of the building. It will be appreciated that, in some cases, there is so much smoke that the firefighter cannot see more than a few inches from his or her face.

FIG. 2 shows hook 10 having chisel tip 10T and hole 10H. Hook 10 may be a Crosby Firefighter Anchor Hook, sold at rocknrescue.com, with a tip breaking strength of 4946 pounds at a load rate of 1.2″ per minute; the impact load of a firefighter exiting a window can reach thousands of pounds of force. The long flat portion of hook 10 between hole 10H and where the curvature of the hook begins is neck 10N. Rope 20 is threaded through hole 10H, and one end of rope 20 is permanently bonded to the body of rope 20, so that hook 10 and rope 20 are permanently connected.

Rope 20 is typically 50 feet in length, 7.5 mm in diameter and comprise of 100% Technora fibers. It has extreme heat and cut resistant properties. It has a 5000 pound breaking strength and can withstand 1.5 to 2 minutes of heat exposure at 932 degrees Fahrenheit.

FIG. 3 shows rope 20 being threaded through slider 30, and the hook-less end of rope 20 being tied into knot 20K. Hook 10, rope 20, slider 30 and carabiner 40 may be the Petzl EXO Personal Safety System (PSS), available from Fire Ground Technologies. Just prior to its loose end, rope 20 is encircled by label 20L, printed with manufacturing identification information, and in some cases, an expiration date. Due to dirt and freezing, rope 20 must be replaced from time to time. Knot 20K prevents rope 20 from sliding completely through slider 30.

Slider 30 has main part 30M, secondary part 30P and tertiary part 30G.

Main part 30M has eave 30E for allowing rope 20 to flow smoothly through a channel for receiving rope 20 (not shown), the channel being between main part 30M and secondary part 30P, loop 30L for arching around rope 20 to restrain its movement direction, hole 30V that is a connector for receiving carabiner 40, hinge 30J and slot 30S.

Secondary part 30P is coupled to main part 30M via hinge 30J and includes cylindrical element 30K that travels in slot 30S, ridge 30R, cylindrical element 30L and hinge 30H. Cylindrical element 30L cooperates with ridge 30R to restrain the movement direction of rope 20. Each of cylindrical elements 30K, 30L has a T-shaped cross section that is orthogonal to the plane of secondary part 30P.

Tertiary part 30G is coupled to secondary part 30P via hinge 30H, and has a generally L-shape, like a boomerang. Tertiary part 30G functions as a throttle lever. When someone's hand extends tertiary part 30G as shown in FIG. 3, rope 20 travels freely through slider 30. Conversely, when tertiary part 30G is not extended, it automatically returns to a resting position (not shown) in which main part 30M, secondary part 30P and tertiary part 30G are generally aligned, and in which rope 20 is unable to travel.

When descending, a firefighter must hold tertiary part 30G is its extended position. If the firefighter lets go, slider 30 returns to its resting position, and rope 20 does not feed. The firefighter can vary the rate at which rope 20 feeds through slider 30 by holding tertiary part at different extensions between its fully extended position and its resting position, that is, use tertiary part 30G as a “gas pedal”.

Slider 30 enables the firefighter to control his or her rate of descent, so that the escape is mostly sliding down the rope, which is far easier than trying to climb down an unfamiliar wall in emergency conditions.

A carabiner is a hinged loop, with a safety clasp, that is normally in its closed position as a loop. However, the hinge enables the loop to be opened, clipped around something else, then closed.

Carabiner 40 has a generally oval shape. Carabiner 40 may be formed of aluminum. At one end, diagonal beam 40B limits the range of motion of carabiner 40 through hole 30V on main party 30M of slider 30. Along one long arm of carabiner 40, there is provided case 40C. Case 40C has a resting position that keeps carabiner 40 in an oval. It is possible to turn case 40C to a release position, which allows part of the arm to rotate about a hinge to create an opening so that carabiner 40 can be clipped around something, and then rotate part of the arm back to its original position and turn case 40C to its resting position. Carabiner 40 must be clipped to D-ring 70D of harness 70 for the escape system to function properly.

FIG. 4 is a three-dimensional view of bag 50 showing back 50B, left side 50L and top 50T that extends into protective flap 50F. Left side 50L has a vertical slit in its top portion, for allowing rope 20 to feed from bag 50. Bag 50 may be the Morning Pride FDNY Rope Pocket, available from Honeywell First Responder Products, made of a Kevlar/Nomex blended material, having a width of 7.5 inches, a height of 8 inches and a depth of 2 inches. Alternatively, bag 50 may be the Firefighter Escape System 557 Lumbar PSS Rope Carry Bag, available from All Hands Fire Equipment. Model 557C is made of Cordura and weighs 2 pounds. Model 557FR is made of PBI, Arashield and Kevlar, and weighs 2.5 pounds.

Straps 54T and 54B are sewn into the upper portion of the seam between back 50B and left side 50L, and have removable fastening on their bases (not shown), such as the hook portion of VELCRO hook and loop fastener. At the top left outside edge of protective flap 50, there is provided complementary fastening, such as the loop portion of VELCRO hook and loop fastener. Straps 54T, 54B prevent rope 20 from falling out of bag 50 when the firefighter is operating normally, that is, not escaping.

Strap 51 extends horizontally along the base of bag 50, and is threaded around leg strap 70R of harness 70 (shown in FIG. 1). The left (distal) end of strap 51 has female snap portion 51F. To the right of the proximal end of strap 50, there is provided male snap portion 51M on back 50B. After strap 51 is looped around leg strap 70R, snap portions 51F, 51M are coupled together.

Vertical strap 52L and diagonal strap 52R are at opposite upper edges of back 50B, for coupling around belt 70W of harness 70 (shown in FIG. 1). Inner strap 53L has one end affixed to an intermediate portion of strap 52L. Inner strap 53R has one end affixed to an intermediate portion of strap 52R. The inner side of straps 52L, 52R from the top edge of bag 50 to the loose end is covered with the hook portion of VELCRO fastener, the inner side of straps 52L, 52R from the top edge of bag 50 to the fastened end is covered with the loop portion of VELCRO fastener. The outer (top) edge of straps 53L, 53R is covered with the loop portion of VELCRO fastener.

To couple bag 50 to belt 70W, straps 52L, 52R are laid open, and belt 70W is positioned along the top edge of back 50B, above the affixion point of straps 53L, 53R. Then, straps 53L, 53R are folded upwards, encircling belt 70W. Next, straps 52L, 52R are folded downwards, and the hook fasteners on 52L, 52R make contact with the loop fasteners on 53L, 53R and then with the loop fasteners on the bottom ends of 52L, 52R. Finally, female snap portions 52FL, 52FR, located at the loose ends of straps 52L, 52R are coupled to male snap portions 52ML, 52MR located at the fastened ends of straps 52L, 52R. The result is extremely sturdy loops at the top of back 50B encircling belt 70W.

FIG. 5 is a three dimensional frontal view of bag 50, showing the inside of flap 50F, a portion of flap 50F folded to form top 50T, right side 50R, the upper portion of left side 50L, the upper inside of back 50B and face 50. Bag 50 also has a rectangular bottom side (not shown), the edges of the bottom side being respectively connected to right side 50R, left side 50, back 50B and face 50Q.

Face 50Q, back 50B, left side 50L and right side 50R form a pocket for holding coiled rope 20. Affixed to the inside of back 50B, near the top, is panel 55. The bottom of the loose long end of panel 55 has a strip of hook fasteners, which mate with a strip of loop fasteners (not shown) along the inside of face 50Q, thereby enabling panel 55 to serve as a lid for the rope pocket and a floor for a pocket for holding slider 30. When flap 50F is lowered to be parallel to face 50Q, top 50T forms a lid for the slider pocket.

Face 50Q has notch 50N along its top edge, for facilitating the placement of rope 20 (see FIG. 6).

Panel 56 is positioned parallel to face 50Q so that the sides and bottom of panel 56 are sewn into the seams of the sides and bottom of bag 50. The top edge of panel 56 is free and forms a pocket for holding hook 10. The top edge of panel 56 is reinforced, such as having a piece of cord sewn therein, forming reinforced edge 56G that is sturdy. Patch pocket 57 is positioned diagonally on panel 56, for holding tip 10T of hook 10. Patch pocket 57 is sewn to panel 56 along its sides and bottom, with its top edge being free.

Flap 50F has to be easy for a firefighter to quickly recognize, despite the firefighter being in a hurry, wearing thick gloves, and unable to see bag 50 because it is worn at the back of the waist, and while crouched, to avoid the worst smoke. Accordingly, at the left side of the top of flap 50F, a large rectangular patch, indicator tab 50X, is attached, to make it easy for the firefighter to kinesthetically distinguish the left side from the right side of flap 50F. A central portion of the top of flap 50F is folded down to create a U-shape. The top folded edge of flap 50F is reinforced, such as having a piece of cord sewn therein, forming reinforced edge 50G that is sturdy and easy to grab. The top right side of flap 50F has small tab 50Y.

The inside of flap 50F has hook fasteners 58A, 58C, 58E that mate with corresponding loop fasteners 58B, 58D, 58F on face 50Q when flap 50F is folded to be parallel to face 50Q. Specifically, hook fasteners 58A mate with loop fasteners 58B, hook fasteners 58C mate with loop fasteners 58D, and hook fasteners 58E mate with loop fasteners 58F.

The bottom of bag 50 (not shown) is a panel with 2 grommets, to permit airflow.

FIG. 6 is a three dimensional frontal view of bag 50 packed with hook 10, rope 20, slider 30 and carabiner 40. Hook 10 is placed in the pocket formed by panel 56 and face 50Q. Chisel tip 10T of hook 10 is placed in pocket 57. Rope 20 runs through notch 50N and into slider 30; slider 30 is placed in the pocket formed by top 50T, left side 50L, right side 50R and panel 55 (panel 55 serves as the floor of the slider pocket). Rope 20 emerges from slider 30 and the remainder of rope 20 is coiled into the pocket formed by panel 55 (serving as a lid), the bottom of bag 50, left side 50L and right side 50R (see FIG. 5). Carabiner 40 attached to slider 30 pokes out through the slit at the top of left side 50L.

It will be appreciated that the escape system is used in emergency conditions, generally life-threatening, such as when a fire cannot be controlled by the firefighter, when the firefighter believes that the floor or ceiling is about to collapse, or when the firefighter believes something is about to explode. Accordingly, improvements that make the escape system easier and/or faster to use are most welcome.

### SUMMARY OF THE INVENTION

In accordance with an aspect of this invention, there is provided an escape system comprising a harness, pants, a hook, a rope, a slider, a carabiner and a bag.

The harness has a D-ring, a belt, and left and right leg straps.

The pants have harness connectors for respectively attaching the belt, the left leg strap and the right leg strap.

The hook has a rope connector.

The rope is attached to the rope connector of the hook.

The slider has a channel for receiving the rope, a handle for controlling the rate of flow of the rope through the channel, and a carabiner connector.

The carabiner is attached to the carabiner connector of the slider and has an end for removably attaching to the D-ring of the harness.

The bag has a front side, a back side, a bottom side, a left side and a right side forming a rope pocket for holding the rope. The back side has harness connectors for respectively attaching to the belt and one of the leg straps of the harness, and extends into a flap. The flap has a closure connector for connecting to the front side and having a hook connector for attaching to the hook.

The bag is packed so that the rope is packed into the rope pocket and threaded through the channel of the slider, the slider and the carabiner are packed in the bag on top of the rope, the hook connector of the flap is attached to the hook, the hook is inside the bag, and the closure connector of the flap is connected to the front side.

In use, when the flap is pulled away from the front side, the hook is automatically pulled out of the bag.

In some instances, the hook is packed into a hook pocket on the front side of the bag.

In other instances, the hook is connected along the edge of the flap. It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 shows a firefighter using a prior art escape system;

FIG. 2 shows hook 10 attached to rope 20;

FIG. 3 shows slider 30 attached to carabiner 40 and threaded with rope 20;

FIG. 4 is a three-dimensional view of the back and left side of bag 50;

FIG. 5 is a three dimensional frontal view of bag 50;

FIG. 6 is a three dimensional frontal view of bag 50 packed with hook 10, rope 20, slider 30 and carabiner 40;

FIG. 7 shows the inside of the flap of bag 100 according to the present invention;

FIG. 8 shows bag 100 packed with hook 10 and rope 20;

FIG. 9 shows the inside of the flap of bag 100 after it has been removed in an emergency escape;

FIG. 10 shows the outside of the flap of bag 100 after it has been removed in an emergency escape;

FIG. 11 shows the inside of the flap of bag 200;

FIG. 12 shows the front face of bag 200;

FIGS. 13A and 13B show the front and back of pocket 207;

FIGS. 14A and 14B show the front and back of sleeve 209; and

FIG. 15 shows the inside of the flap of bag 200 packed with hook 10 and rope 20.

### DETAILED DESCRIPTION

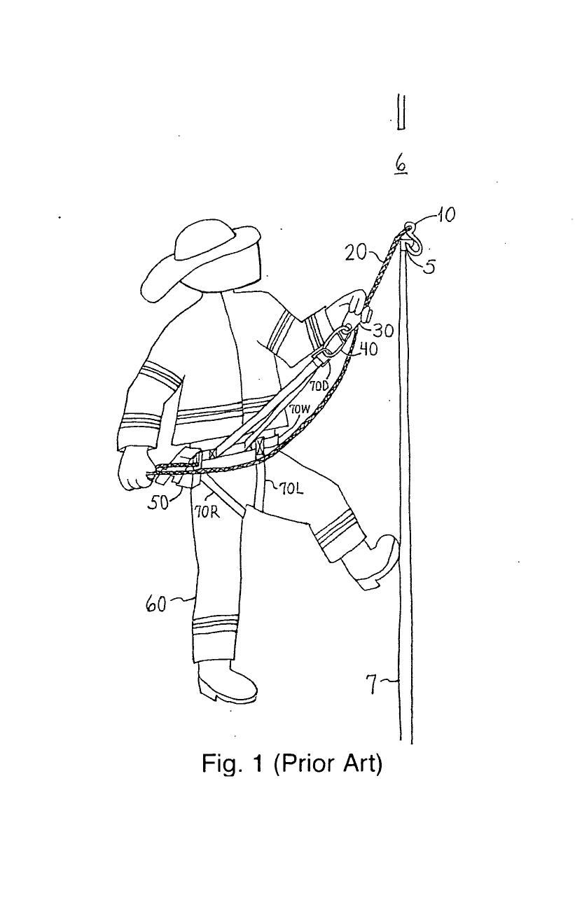

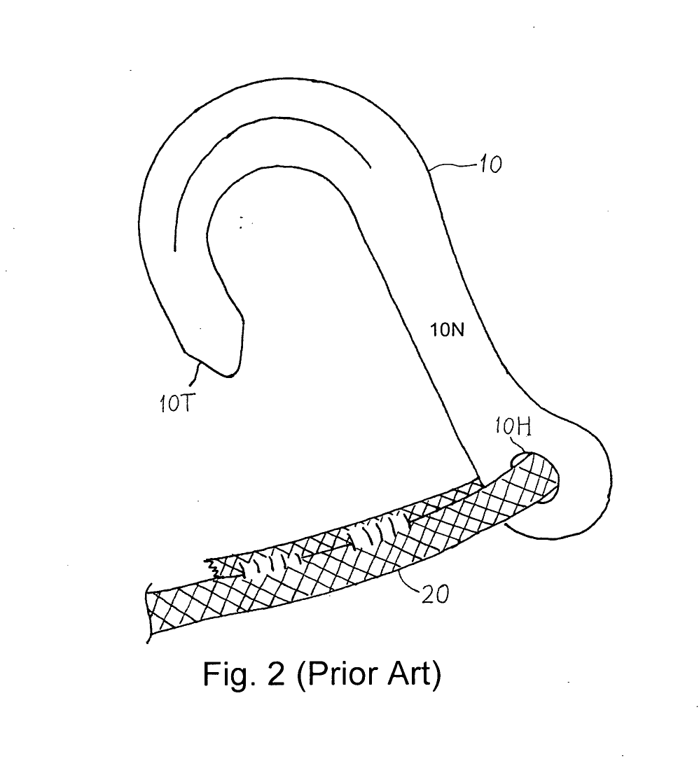

It is helpful to analyze, in detail, how the conventional escape system of FIG. 1 is used in an emergency, recalling that the ambient conditions are likely to be horrible.

First, the firefighter reaches behind his or her body to find indicator tab 50X.

Second, the firefighter places his or her fingers under reinforced edge 50G.

Third, the firefighter pulls up on edge 50G to expose the contents of bag 50 to his or her hand.

Fourth, the firefighter grabs hook 10 and attaches it to something, typically the frame of the window, such as window sill 5 in FIG. 1.

Fifth, the firefighter perches or lays on the window edge, causing rope 20 to begin feeding out of bag 50.

Sixth, the firefighter rolls out the window, causing D-ring 70D of harness 70 to shift so that slider 30 ends up in front of the firefighter's face, although perhaps not visible due to smoke. The firefighter is now suspended in harness 70, having D-ring 70D connected to carabiner 40 that is coupled to slider 30 that is locked around rope 20 whose distal end is attached to hook 10 that is planted in the building.

Seventh, the firefighter uses tertiary part 30G of slider 30 as a “gas pedal” to begin calmly descending down the outside wall.

The fourth step, grabbing the hook, has frequently presented problems during training for use of the escape system, because it is hard to grab the hook from its position while wearing thick firefighting gloves. Groping to remove the hook delays a firefighter from the next step for precious seconds, which could make a difference between life and death.

According to the present invention, an improved escape device automatically pulls the hook out of its stored position when the flap of the bag is raised at the third step, substantially eliminating the difficulty encountered with the conventional escape system at the fourth step.

The present invention is similar to the conventional escape system described above, and only differences will be discussed for brevity. When the present invention is used as an escape system for firefighters, all materials must meet NFPA standards.

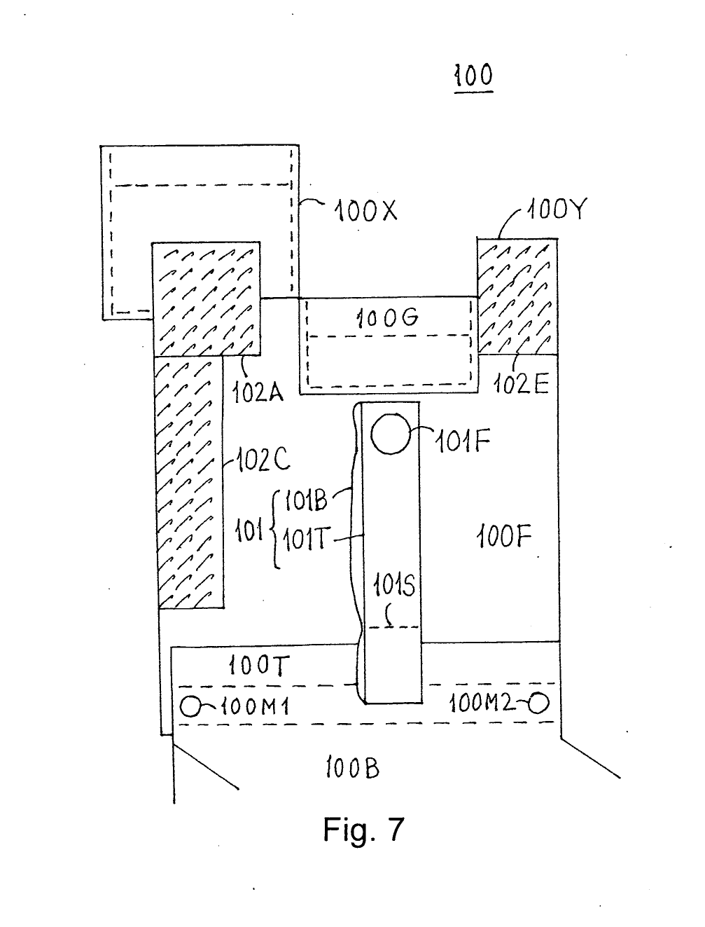

FIG. 7 shows an upper portion of bag 100, including flap 100F and the attachment of flap 100F to the body of bag 100. The remainder of bag 100 is similar to bag 50, and will not be discussed for brevity.

Flap 100F is somewhat similar to flap 50F, and only differences will be discussed, for brevity. There are two major differences between flap 100F and flap 50F: detachability and hook harness 101.

One difference between flap 100F and flap 50F is that flap 100F is completely detachable from bag 100.

As shown in FIG. 7, back 100B extends above the top edge of sides 100R and 100L to form top panel 100T. Snap portions 100M1 and 100M2 are located at the left and right side of top panel 100T. A strip of loop fasteners (not shown) is sewn between snap portions 100M1 and 100M2, on the outside of top panel 100T.

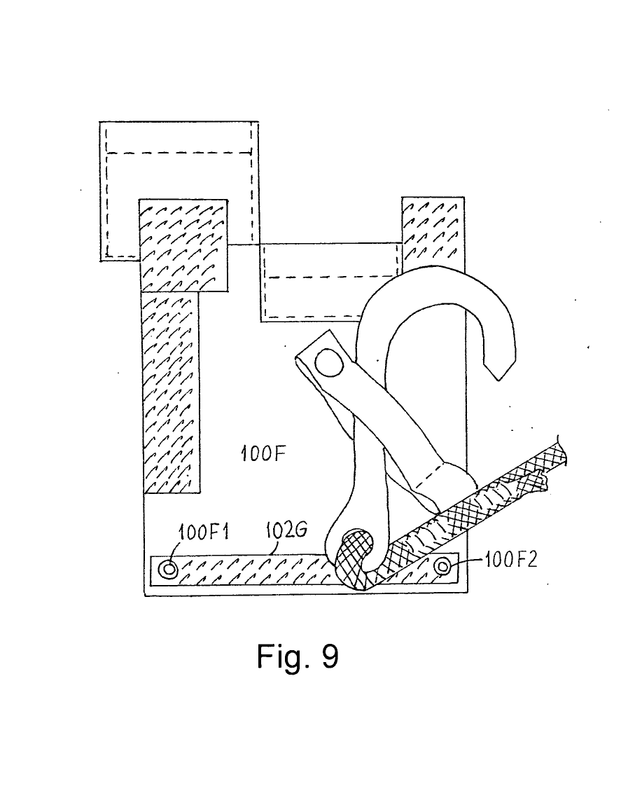

Flap 100F has a strip of hook fasteners 100G sewn horizontally across its bottom edge, between snap portions 100F1 and 100F2 that respectively mate with snap portions 100M1 and 100 M2 (see FIG. 9).

When edge 100G is pulled with sufficient force, flap 100F separates from bag 100.

Another difference between flap 100F and flap 50F is that flap 100F includes hook harness 101 that is placed around hook neck 10N while packing bag 100 prior to responding to an emergency.

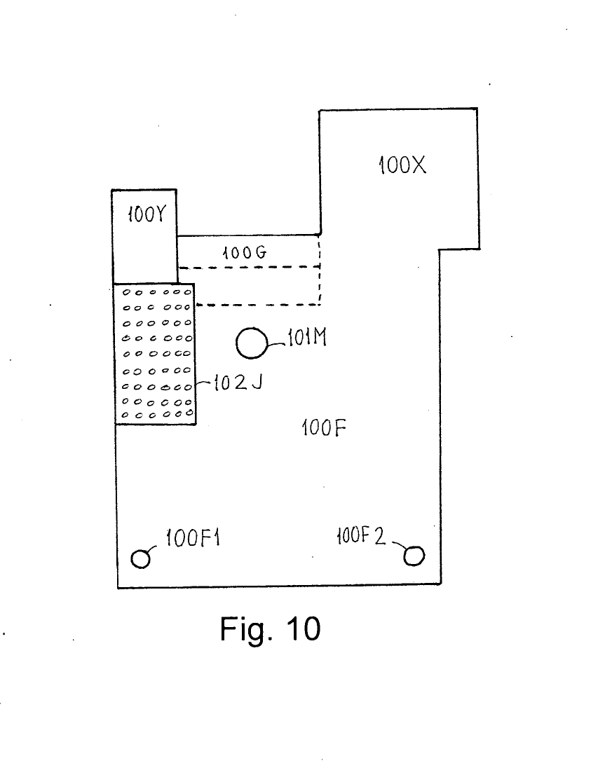

Hook harness 101 has top strap 101T and bottom strap 101B. A simple way to make hook harness 101 is to cut a length of strap material, such as rope or webbing, fold it in half, secure the loose ends using snap portion 101F, and sew seam 101S a short amount from the fold. Polyester webbing is preferred as it is resistant to water absorption. Instead of sewing seam 101S, it may be formed of metal or plastic fasteners. Snap portion 101F mates with snap portion 101M that is affixed to flap 100F (see FIG. 10).

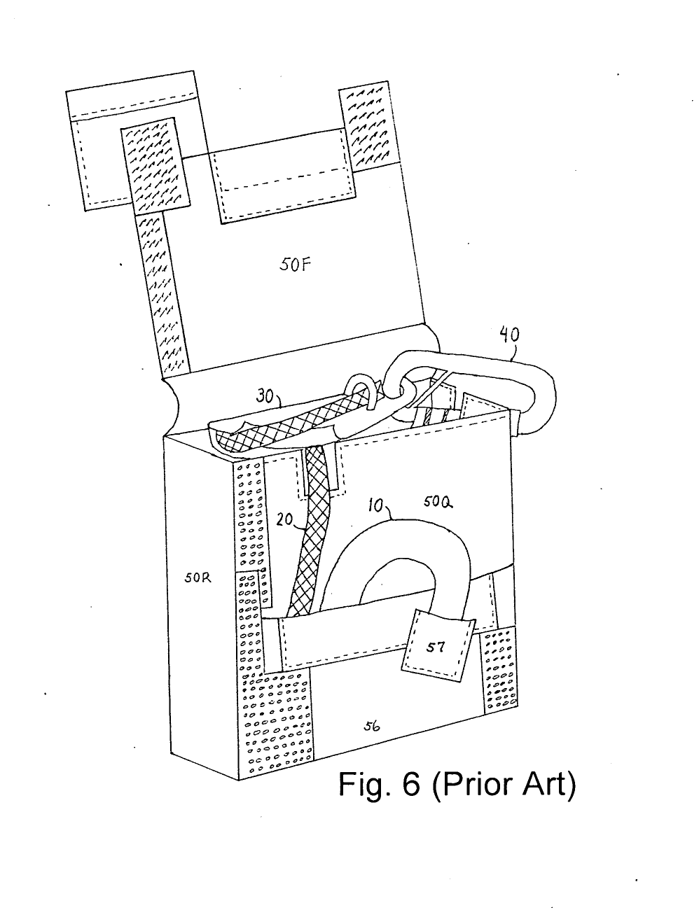

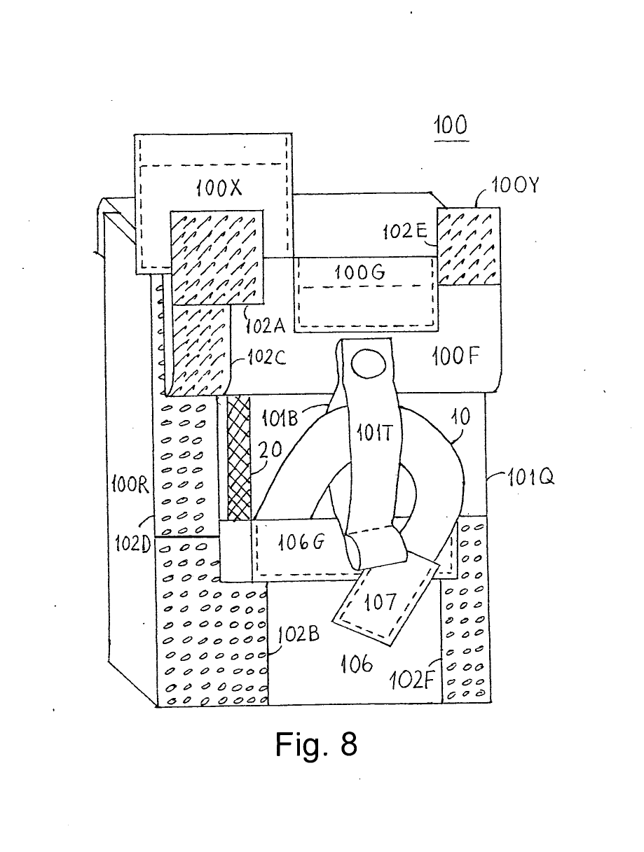

FIG. 8 shows bag 100 packed with hook 10 and rope 20. Flap 100F is shown folded back to expose how hook 10 is placed relative to hook harness 101. Otherwise, bag 100 is packed similarly to bag 50 shown in FIG. 6. Face 101Q of bag 100 is similar to face 50Q of bag 50.

FIG. 9 shows the inside of flap 100F of bag 100 after it has been removed in an emergency escape. Importantly, hook harness 101 automatically pulls hook 10 out of the hook pocket formed by panel 106 and face 101Q (see FIG. 8).

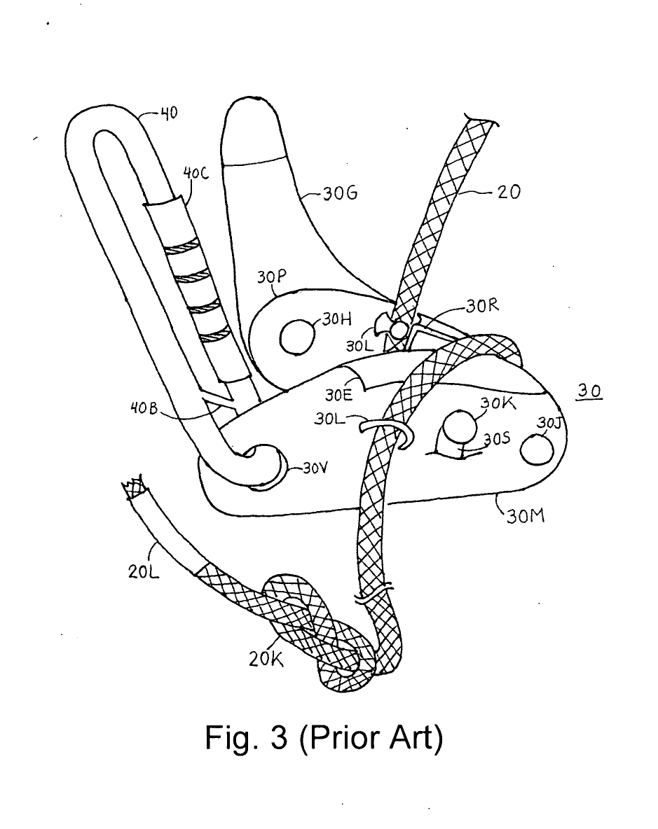

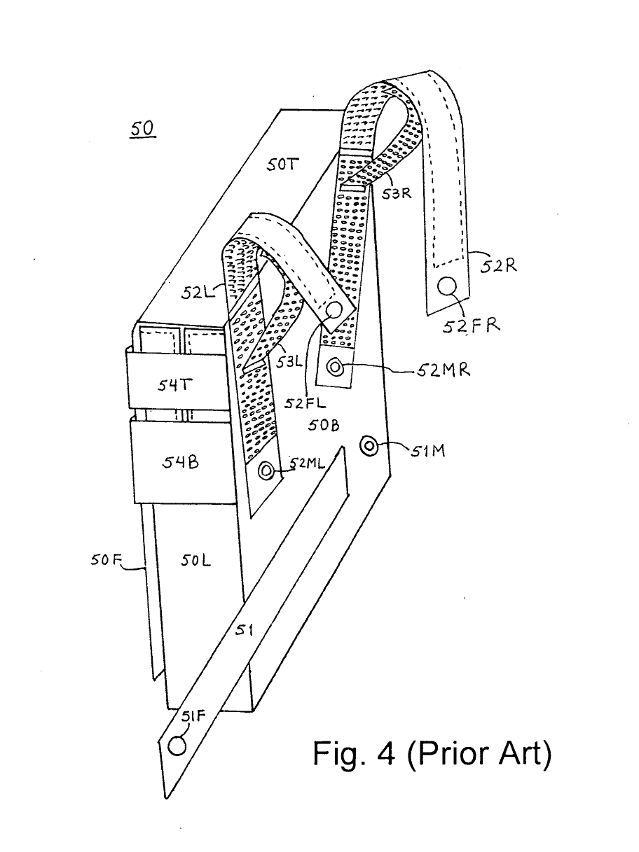

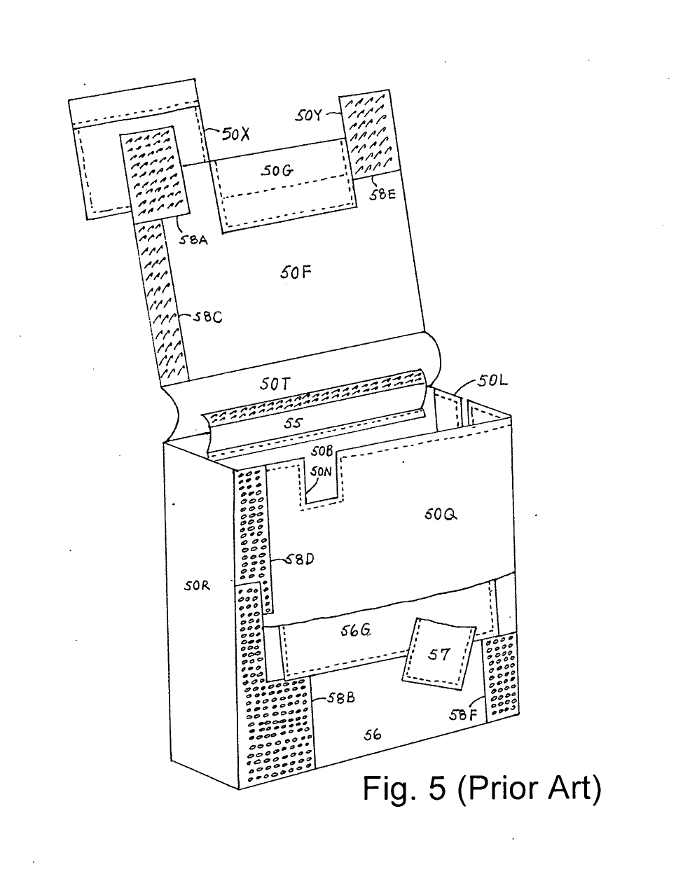

FIG. 10 shows the outside of flap 100F of bag 100 after it has been removed in an emergency escape. Snap portion 101M mates with snap portion 101F of hook harness 101; snap portions 100F1 and 100F2 respectively mate with snap portions 100M1 and 100M2 (see FIG. 7). Loop fasteners 102J mate with hook fasteners on the underside of straps 101T and 101B (not shown) of bag 100, corresponding to straps 54T and 54B shown in FIG. 3.

Bag 100 is used similarly to bag 50, except that at the third step, the firefighter pulls edge 50G until flap 100F separates from bag 100. This is an easy thing to do even under the terrible conditions of an emergency. Accordingly, at the fourth step, the firefighter does not need to remove hook 10 from a pocket, but merely grab hook 10 that is held in hook harness 101 suspended from flap 100F that is already in the firefighter's hand. This is also an easy thing to do, even while wearing thick firefighter gloves.

Hook harness 101 is connected to flap 100F using a snap. Instead of a snap, VELCRO hook and loop fasteners can be used to connect hook harness 101 to flap 100F, or hook harness 101 can be permanently sewn or otherwise affixed to flap 100F. At the fourth step, the firefighter can easily pull flap 100F away from hook 10, leaving hook harness 101 encircling hook 10, in which condition hook 10 can be immediately planted, such as in window sill 5.

Accordingly, bag 100 eliminates the fumbling for hook 10 that occurs during emergency use of bag 50, which results in faster use of the escape system. Bag 100 also improves ease of use of the escape system.

Another embodiment of the present invention will now be described. In this embodiment, the hook is stored at the edge of the flap, so that after the firefighter grabs the flap, he or she immediately has the hook in hand. Bag 200 is similar to bag 100, except as described below.

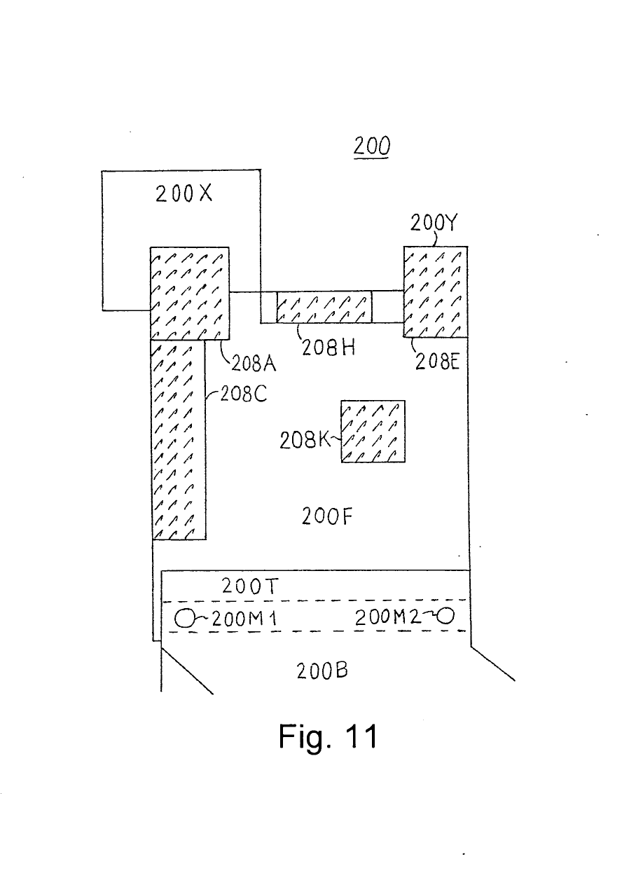

FIG. 11 shows the inside of flap 200F of bag 200. Flap 200F differs from flap 100F of bag 100 in two ways.

First, whereas flap 100F has reinforced edge 100G, flap 200F instead has hook fasteners 208H located in a strip along the free edge of flap 200F, for mating with the back of sleeve 209 (see FIG. 14B).

Second, whereas flap 100F has snap part 101M for attaching hook harness 101, flap 200F instead has hook fasteners 208K at an intermediate point, for mating with the back of pocket 207 (see FIG. 13B).

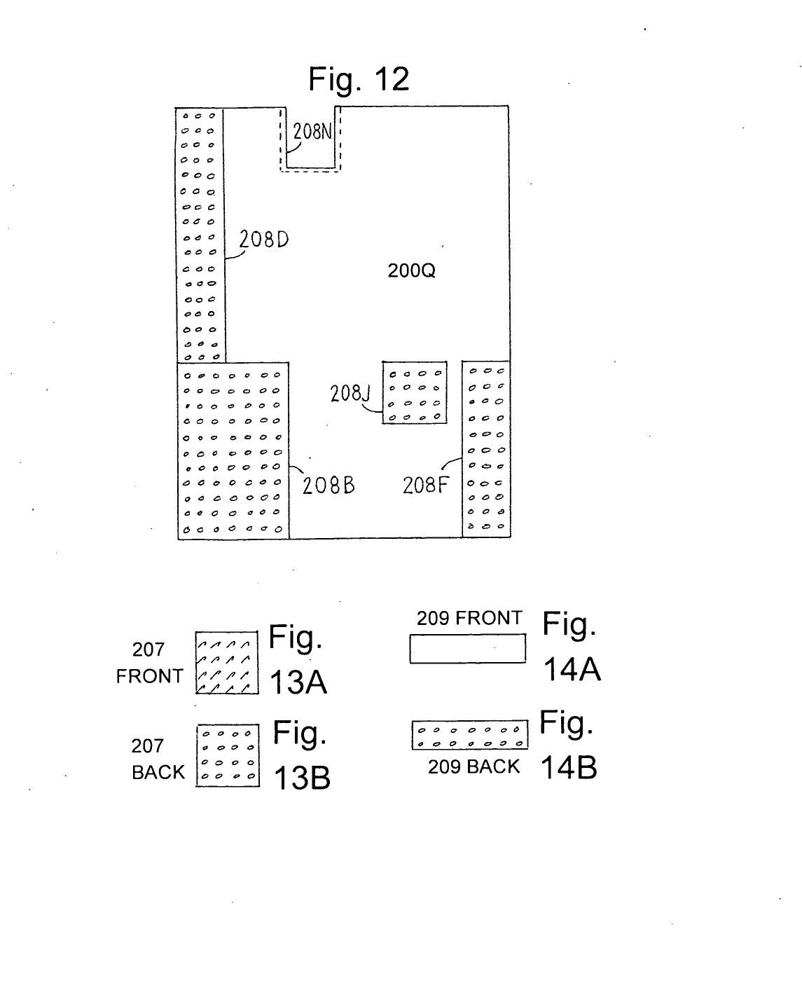

FIG. 12 shows front face 200Q of bag 200. Face 200Q differs from face 101Q of bag 100 in that whereas face 101Q has front panel 106 to which is affixed hook tip pocket 107, face 200Q instead has loop fasteners 208J, for mating with the front of pocket 207 (see FIG. 13A).

FIGS. 13A and 13B show the front and back of pocket 207. The front of pocket 207 is covered with hook fasteners and the back of pocket 207 is covered with loop fasteners. Pocket 207 is closed along its sides and bottom, and open along its top.

FIGS. 14A and 14B show the front and back of sleeve 209. The front of sleeve 209 is made of the same material as bag 200. The back of sleeve 209 is covered with loop fasteners.

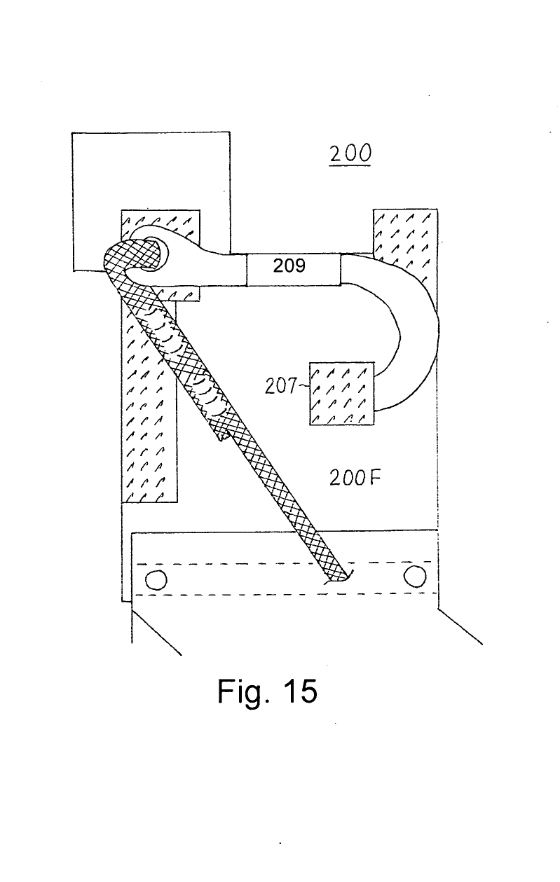

FIG. 15 shows the inside of the flap of bag 200 packed with hook 10 and rope 20. Sleeve 209 is placed around neck 10N of hook 10, and the back of sleeve 209 is mated with hook fasteners 208H along the loose end of flap 200F. Tip 10T of hook 10 is placed in pocket 207, and the back of pocket 207 is mated with hook fasteners 208K on the face of flap 200F.

In use, at the third step, the firefighter grabs edge 200G and hook neck 10N simultaneously, pulls flap 200F until it separates from bag 100, and then is already holding hook 10. The firefighter then pulls flap 200F downward, which detaches flap 200F from hook sleeve 209. The pulling downward of flap 200F either removes pocket 207 from hook tip 10T, or leaves pocket 207 on hook tip 10T, and then pocket 207 falls from hook 10 due to gravity.

Now, at the fourth step, grabbing of hook 10 is eliminated because hook 10 is already in the firefighter's hand. The firefighter can go directly to planting hook 10.

Although illustrative embodiments of the present invention, and various modifications thereof, have been described in detail herein with reference to the accompanying drawings, it is to be understood that the invention is not limited to these precise embodiment and the described modifications, and that various changes and further modifications may be effected therein by one skilled in the art without departing from the scope or spirit of the invention as defined in the appended claims.

What is claimed is:

1. An escape system, comprising: a harness having a D-ring, a belt, and left and right leg straps;
pants having harness connectors for respectively attaching the belt, the left leg strap and the right leg strap;
a hook having a neck and a rope connector;
a rope attached to the rope connector of the hook;
a slider having a channel for receiving the rope, a handle for controlling the rate of flow of the rope through the channel, and a carabiner connector;
a carabiner attached to the carabiner connector of the slider and having an end for removably attaching to the D-ring of the harness; and
a bag having a front side, a back side, a bottom side, a left side and a right side forming a rope pocket for holding the rope,
the back side having harness connectors for respectively attaching to the belt and one of the leg straps of the harness, and having a flap connector for removably connecting a flap,
one of the left and right sides having a slit for enabling the rope to flow out of the bag,
the front side having an outside face and a rectangular panel connected to the outside face along three edges of the panel thereby forming a hook pocket,
the bag also having a flap for removably connecting to the flap connector of the back side, the flap having a closure connector for connecting to the front side and having a hook harness for connecting to the neck of the hook;
wherein after
the flap is connected to the back side,
the hook is packed into the hook pocket,
the rope is packed into the rope pocket and threaded through the channel of the slider,
the slider and the carabiner are packed in the bag on top of the rope,
the hook harness of the flap is connected to the neck of the hook, and
the closure connector of the flap is connected to the front side,
when the flap is pulled away from the front side so that the flap detaches from the back side, the hook is automatically pulled out of the hook pocket.

2. An escape system, comprising:
a bag having a front side, a back side, a bottom side, a left side and a right side forming a rope pocket for holding the rope,
the back side having harness connectors for attaching to a harness,
the back side extending into a flap for folding over the rope pocket,
the flap having a hook connector for connecting to a hook and a closure connector for connecting to the front side;
wherein after
a rope is packed into the rope pocket, the rope being connected to a hook,
the hook is packed in the bag,
the flap is connected to the hook, and
the closure connector of the flap is connected to the front side,
when the flap is pulled away from the front side, the hook is automatically pulled out of the bag.

3. The escape system of claim 2, wherein the hook has a neck, and the hook connector of the flap is a hook harness for encircling the neck of the hook.

4. The escape system of claim 3, wherein the front side has a rectangular panel attached thereto forming a hook pocket, and the hook is packed in the hook pocket.

5. The escape system of claim 3, wherein the flap is removable from the back side.

6. The escape system of claim 3, wherein the hook harness is formed of webbing.

7. The escape system of claim 3, wherein the hook harness is formed of rope.

8. The escape system of claim 3, further comprising
the hook;
the rope connected to the hook;
a slider having a channel through which the rope is threaded, a handle for controlling the rate of flow of the rope through the channel, and a carabiner connector; and
a carabiner attached to the carabiner connector of the slider.

9. The escape system of claim 8, further comprising a harness having bag connectors for attaching to the bag, a carabiner connector for attaching to the carabiner, and pants connectors for attaching to pants.

10. The escape system of claim 9, further comprising pants having connectors for attaching to the harness.

11. The escape system of claim 2, wherein the hook has a neck, further comprising a sleeve for encircling the neck of the hook and having one of a hook and loop connector disposed on the outside of the sleeve, and wherein the hook connector of the flap is the other of the hook and loop connector for mating with the sleeve.

12. The escape system of claim 11, wherein the hook has a tip, further comprising a tip pocket connected to the flap, and wherein the hook is packed so that the tip of the hook is in the tip pocket.

13. The escape system of claim 12, wherein the tip pocket is removable from the flap.

14. The escape system of claim 11, wherein the flap is removable from the back side.

15. The escape system of claim 11, wherein the hook connector is located along an edge of the flap.

16. The escape system of claim 11, further comprising
the hook;
the rope connected to the hook;
a slider having a channel through which the rope is threaded, a handle for controlling the rate of flow of the rope through the channel, and a carabiner connector; and
a carabiner attached to the carabiner connector of the slider.

17. The escape system of claim 16, further comprising a harness having bag connectors for attaching to the bag, a carabiner connector for attaching to the carabiner, and pants connectors for attaching to pants.

18. The escape system of claim 17, further comprising pants having connectors for attaching to the harness.
